(19) United States
(12) Patent Application Publication
(10) Pub. No.: US 2010/0314594 A1
(43) Pub. Date: Dec. 16, 2010

(54) HOIST

(76) Inventor: Tiong Bin Seow, Singapore (SG)

Correspondence Address: AXIS INTELLECTUAL CAPITAL PTE LTD., 21 Science Park Road, #03-01 The Aquarius Science Park II, SINGAPORE, 117628, SG

(21) Appl. No.: 12/735,573

(22) PCT Filed: Jan. 30, 2009
(86) PCT No.: PCT/SG2009/000038

§ 371 Date: Jul. 28, 2010

(30) Foreign Application Priority Data
Jan. 30, 2008 (SG) 200800847-6

(51) Int. Cl. B66D 1/36; B66D 1/04; B66D 1/12

(52) U.S. Cl. 254/333

(57) ABSTRACT

Hoists for hoisting loads by means of a cable are in existence for a long period. There are various types of hoists, which include winches and capstans. Generally, the principle of operation of a hoist is based on the cable being driven by adherence of the cable to the drum of the hoist. A hoist is described according to an embodiment of the present invention. The hoist comprises a drum, a plurality of guides, a guide support and a biasing device for displacing a portion of a cable away from the guide when the drum is rotationally displaced to thereby hoist a load.

### FIELD OF INVENTION

The invention relates generally to load hoisting, and more particularly to a hoist for hoisting a load by means of a cable.

### BACKGROUND

Hoists for hoisting loads by means of a cable have long existed. Generally, the principle of operation of a hoist is based on the cable being driven by adherence of the cable to the drum of the hoist. The drum holds the cable by friction, which operates as the principal power means for drawing in the cable for winding around the drum. As tension that is applied to the cable increases, the cable stretches and its linear speed decreases accordingly.

There are various types of hoists, which include winches and capstans. A winch is used to wind up a cable in which one end of the cable is fixed and the cable is generally stored on the drum of the winch. Besides industrial applications, for example on lifting cranes, winches are also used on vehicles for towing cars and boats. Winches are widely used for hoisting loads as they provide mechanical advantage to users. However, a drawback of using a winch to hoist a load is that sufficient tension must be constantly maintained on the turns for the cable to be suitably wound and stored on the drum. Typically, a guide mechanism is used for progressively guiding the cable across the length of the drum as the cable is being wound onto the drum.

Capstans are similar to winches with the exception that the cable is not stored on the drums. Hence, capstans do not have the problem of constantly maintaining sufficient tension on the turns for the cable to be suitably wound and stored on the drums. Capstans are rotating machines used to apply force to another element and are typically used on board ships and on dock walls for heaving or veering ropes, cables and hawsers. When a capstan is in operation, only a portion of the cable is wound around the drum of the capstan. A load can be attached to one of the free ends for the capstan to hoist the load. However, as the cable is driven by adherence of the cable to the drum of the capstan, sufficient frictional force is needed between the cable and the drum for operation of the capstan.

Japanese Patent Application Number 20040163404 to Fumiaki discloses an endless type winch having a configuration capable of towing and driving a winch without winding a rope by utilising a part around a driving mechanism of an existing winch as it is. The endless type winch comprises a winding drum having a rope channel at the outer periphery, a pair of rope gripping guide sheaves and a supporting frame. The pair of rope gripping guide sheaves is arranged in positions where the rope winds around the rope channel of the winding drum so as to increase contact frictional force of the rope for the rope channel. However, as the rope elastically contracts due to its tension diminishing in passing through the endless type winch, the length of the rope changes continuously. The rope slides against the rope channel of the winding drum for accommodating the changing rope length, which results in wear and tear of the rope. Further, the sliding of the rope against the rope channel increases slippage of the rope between the drum and the rope gripping guide sheave.

Therefore, there is a need for a hoist, which addresses at least one of the aforementioned problems.

### SUMMARY

The present embodiment of the invention disclosed herein provides a hoist for hoisting a load by means of a cable.

In accordance with a first aspect of the invention, a hoist comprising a drum, a biasing mechanism and at least one guide is disclosed. The drum comprises a drum surface for supporting a cable thereon and the cable has an anchored end. The at least one guide is coupled to the biasing mechanism and the biasing mechanism is for biasing the at least one guide towards the drum for clasping at least one portion of the cable between the at least one guide and the drum. This is to substantially adhere the clasped at least one portion of the cable to the drum surface. When a portion of the cable extending between the anchored end and the drum is in tension, slippage between the drum surface and the clasped at least one portion of the cable is substantially impeded and the drum is rotationally displaceable for displacing the clasped at least one portion of the cable away from the at least one guide.

In accordance with a second aspect of the invention, a hoist comprising a drum, a plurality of guides, a guide support and a biasing device is disclosed. The drum comprises a drum surface for supporting a cable thereon and the cable has an anchored end. The guide support is for inter-coupling the plurality of guides. The biasing device cooperates with the guide support for biasing the plurality of guides towards the drum for clasping at least one portion of the cable between the plurality of guides and the drum. This is to substantially adhere the clasped at least one portion of the cable to the drum surface. When a portion of the cable extending between the anchored end and the drum is in tension, slippage between the drum surface and the clasped at least one portion of the cable is substantially impeded and the drum is rotationally displaceable for displacing the clasped at least one portion of the cable away from the plurality of guides.

In accordance with a third aspect of the invention, a cable adherence apparatus comprising a plurality of guides, a guide support and a biasing device is disclosed. The guide support is for inter-coupling the plurality of guides and is coupled to the biasing device. The biasing device is couplable to a drum assembly that comprises a drum. The drum has a drum surface for supporting a cable thereon and the cable has an anchored end. The biasing device is for cooperating with the guide support for biasing the plurality of guides towards the drum for clasping at least one portion of the cable between the plurality of guides and the drum. This is to substantially adhere the clasped at least one portion of the cable to the drum surface. When a portion of the cable extending between the anchored end and the drum is in tension, slippage between the drum surface and the clasped at least one portion of the cable is substantially impeded and the drum is rotationally displaceable for displacing the clasped at least one portion of the cable away from the plurality of guides.

In accordance with a fourth aspect of the invention, a hoist comprising a drum and a plurality of guide members is disclosed. The drum has a drum surface for supporting a cable thereon and the cable has an anchored end. The plurality of guide members are one of biasable toward and displaceable away from the drum surface. The plurality of guide members comprise a first guide member and second guide members. The first guide member guides the cable to the drum and the second guide members clasp at least one portion of the cable between the second guide members and the drum. Guidance of the cable via the first guide member biases the second guide members toward the drum surface to substantially adhere the clasped at least one portion of the cable to the drum surface. When a portion of the cable extending between the anchored end and the drum is in tension, slippage between the drum surface and the clasped at least one portion of the cable is substantially impeded and the drum is rotationally displaceable for displacing the clasped at least one portion of the cable away from the plurality of guide members.

In accordance with a fifth aspect of the invention, a hoist comprising a drum, a plurality of guide members and a biasing device is disclosed. The drum has a drum surface for supporting a cable thereon and the cable has an anchored end. The plurality of guide members are one of biasable toward and displaceable away from the drum surface. The plurality of guide members comprise a first guide member and second guide members. The first guide member guides the cable to the drum and the second guide members clasp at least one portion of the cable between the second guide members and the drum. The biasing device cooperates with the plurality of guide members whereby biasing of the second guide members toward the drum surface releases tension in the biasing device and the displacement of the second guide members away from the drum surface producing tension in the biasing device. When a portion of the cable extending between the anchored end and the drum is in tension, slippage between the drum surface and the clasped at least one portion of the cable is substantially impeded and the drum is rotationally displaceable for displacing the clasped at least one portion of the cable away from the second guide members.

### BRIEF DESCRIPTION OF THE DRAWINGS

An embodiment of the invention is described hereinafter with reference to the following drawings, in which:

FIG. 1 shows a front elevation of a hoist according to an embodiment of the invention;

FIG. 2 shows a cross sectional view of the hoist of FIG. 1 along line A-A;

FIG. 3a shows a side view of a first configuration of a hoist in accordance with another embodiment of the invention, the first configuration comprises a drum, a biasing device, a plurality of guides, a plurality of the guide support and a lever member;

FIG. 3b shows a cross sectional view of the hoist of FIG. 3a along line B-B′; and

FIG. 3c shows a side view of a second configuration of the hoist of FIG. 3a, wherein a plurality of cables are wound round the drum.

### DETAILED DESCRIPTION

A hoist for hoisting a load by means of a cable is described hereinafter for addressing at least one of the aforementioned problems.

For purposes of brevity and clarity, the description of the invention is limited hereinafter to applications relating to hoists. This however does not preclude various embodiments of the invention from other applications. The fundamental concepts of the embodiments of the invention shall remain common throughout the various embodiments.

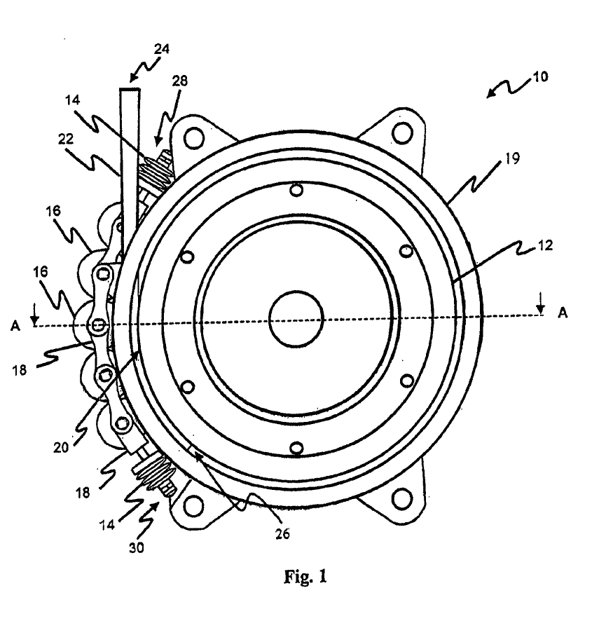

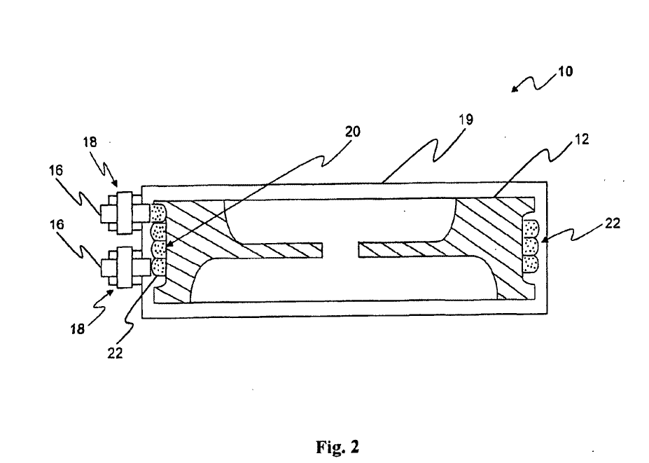

A first embodiment of the invention described in the detailed description provided hereinafter is in accordance with FIG. 1 to FIG. 2 of the drawings, in which like elements are numbered with like reference numerals.

With reference to FIG. 1 and FIG. 2, a hoist 10 is described according to the first embodiment of the invention. The hoist 10 generally comprises a drum 12, a biasing device 14, a plurality of guides 16, a guide support 18 and a housing 19. The biasing device 14 and the guide support 18 form a biasing mechanism. The hoist 10 further comprises an actuator (not shown) operable for controlling rotational displacement of the drum 12. The actuator is preferably an electric motor. Alternatively, the actuator comprises a crank assembly operable for rotationally displacing the drum 12. The drum 12 comprises a drum surface 20 for supporting a cable 22, such as a rope, with the cable 22 having an anchored end 24 and a free end 26. Preferably, the cable 22 is wound around the drum 12 three times, as shown in FIG. 2. However, the cable 22 can be wound around the drum 12 more than three times. Alternatively, the cable 22 is wound around the drum 12 only once. Preferably, the drum surface 20 is substantially cylindrical. Alternatively, the drum surface 20 is substantially hyperbolical.

Furthermore, the drum 12 preferably comprises a groove (not shown) formed on the drum surface 20 that spirals a number of times around the drum 12. The groove is for locating the cable 22 within the groove when the cable 22 is being wound around the drum 12. This is for impeding lateral slippage or travel of the cable 22 off the drum surface 20 when the drum 12 is rotationally displaced. Additionally, the groove is preferably coated with a layer of material for hardening the surface of the groove. The surface of the groove after coating is preferably smooth for reducing friction between the cable 22 and the groove, thus reducing wear and tear of the cable 22, when the drum 12 is rotationally displaced.

Alternatively, the groove formed on the drum surface 20 spirals only once around the drum 12 for locating the cable 22 within the groove. The cable 22 is thus wound around the drum 12 only once.

The guide support 18, such as a chain or roller chain, comprises a first end 28 and a second end 30, and is preferably elongated. The guide support 18 is for inter-coupling the guides 16. Preferably, each of the guides 16 is a roller being rotatably coupled to the guide support 18.

The guide support 18 is further coupled to the biasing device 14. The biasing device 14 is preferably an assembly of one or more springs made from a coil of wire or elastic materials such as polyurethane. The biasing device 14 is coupled to the guide support 18 at the first end 28 and the second end 30 for biasing the first end 28 away from the second end 30. The biasing mechanism is coupled to and supported by the housing 19, which is coupled to the drum 12. Alternatively, the housing 19 is coupled to a frame (not shown) instead of the drum 12. Operatively, the biasing device 14 is for cooperating with the guide support 18 for biasing the guides 16 towards the drum 12 for clasping a portion of the cable 22 between the guides 16 and the drum 12. This is to substantially adhere the clasped portion of the cable 22 to the drum surface 20.

Additionally, more than one portion of the cable 22 is claspable between the guides 16 and the drum 12. To clasp more than one portion of the cable 22, more than one biasing device 14 and one guide support 18 are needed. As illustrated in FIG. 2 where the cable 22 is wound around the drum 12 three times, preferably two portions of the cable 22 are being substantially adhered to the drum surface 20 in which each of the two portions of the cable 22 is being clasped by one biasing device 14 together with one guide support 18. In particular, one of the two clasped portions is a part of the first wind of the cable 22 around the drum 12 and the other of the two clasped portions is a part of the last wind of the cable 22 around the drum 12. This is to ensure that the free end 26 of the cable 22 continues to wind around a portion of the drum 12 after the free end 26 travels across the guides 16 during rotational displacement of the drum 12.

Preferably, the biasing mechanism comprises the biasing device 14 and the guide support 18 for biasing the guides 16 towards the drum 12. Alternatively, another type of biasing mechanism comprising a plurality of biasing arms such as lever arms (not shown) can be provided for biasing the guides 16 towards the drum 12. Each of the guides 16 is coupled to each of the biasing arms and each of the biasing arms is for biasing each of the guides towards the drum 12.

A hoist (not shown) according to a second embodiment of the invention comprises the drum 12, the biasing device 14, the guide support 18 and the housing 19, in which the biasing device 14 and the guide support 18 form a biasing mechanism, as in the hoist 10 of FIG. 1 and FIG. 2 with the exception that this hoist comprises a single guide 16 instead of the plurality of guides 16. Furthermore, as there is only one guide 16 being coupled to the guide support 18, the guide support 18 is only for cooperating with the biasing device 14 for biasing the guide 16 towards the drum 12.

Alternatively, instead of providing the biasing mechanism comprising the biasing device 14 and guide support 18 for biasing the guide 16 towards the drum 12, another type of biasing mechanism comprising a biasing arm (not shown) for coupling the guide 16 thereto, is provided for biasing the guide 16 towards the drum 12.

Additionally, it is known in the art that besides the biasing mechanism described in each of the first and second embodiments of the invention, other types of biasing mechanism for biasing the guides 16 towards the drum 12 are implementable. Further, the preferred embodiment of the invention is the hoist 10 as described according to the first embodiment of the invention, which comprises the guides 16 and the type of biasing mechanism that comprises the biasing device 14 and the guide support 18.

Referring back to FIG. 1 and FIG. 2, when the hoist 10 is in use for hoisting a load (not shown), the portion of the cable 22 extending between the anchored end 24 and the drum 12, as well as the portion of the cable 22 wound into the groove are in tension. Consequently, slippage between the drum surface 20 and the two clasped portions of the cable 22 is substantially impeded. Further, the drum 12 is rotationally displaceable for displacing the two clasped portions of the cable 22 away from the guides 16. The guides 16 which are biased onto the cable 22 apply sufficient force thereto for adhering the cable 22 to the drum surface 20 without impeding travel of the cable 22 across the guides 16 when the drum 12 is rotationally displaced to thereby hoist the load. Further, the free end 26 of the cable 22 can be collected using a wheeler (not shown) as the drum 12 is being rotationally displaced.

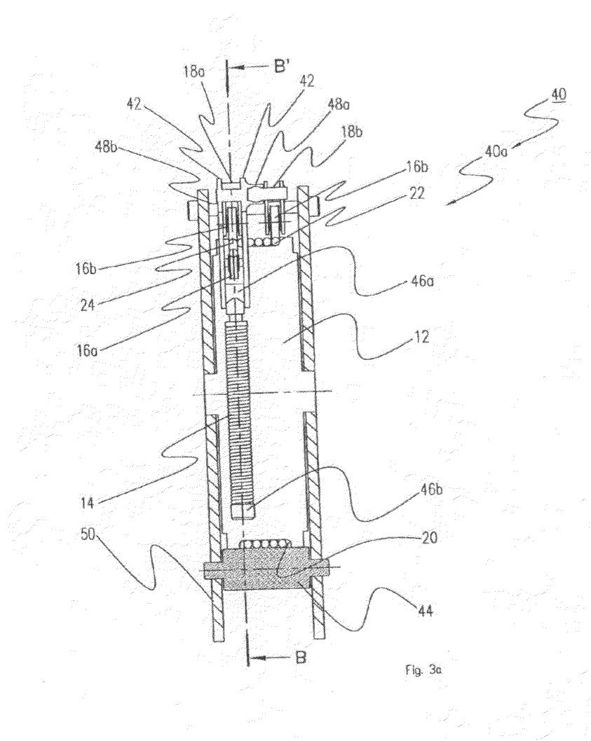

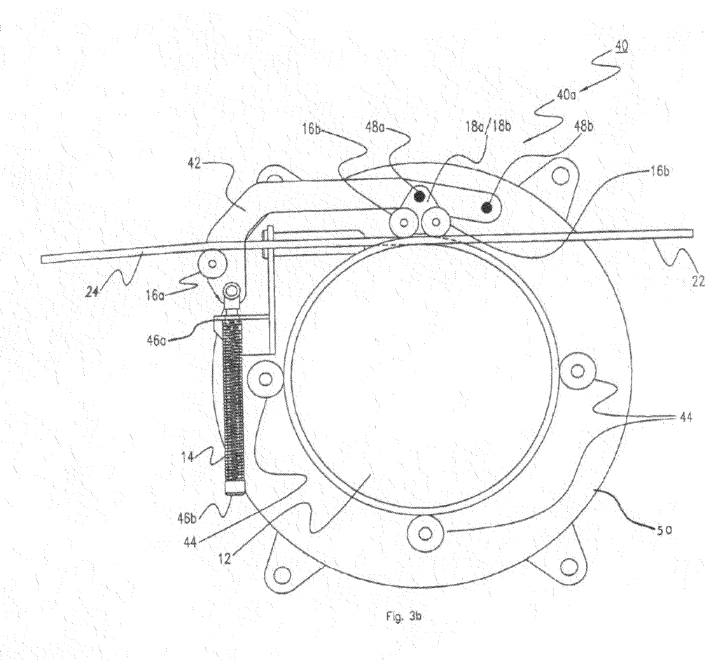

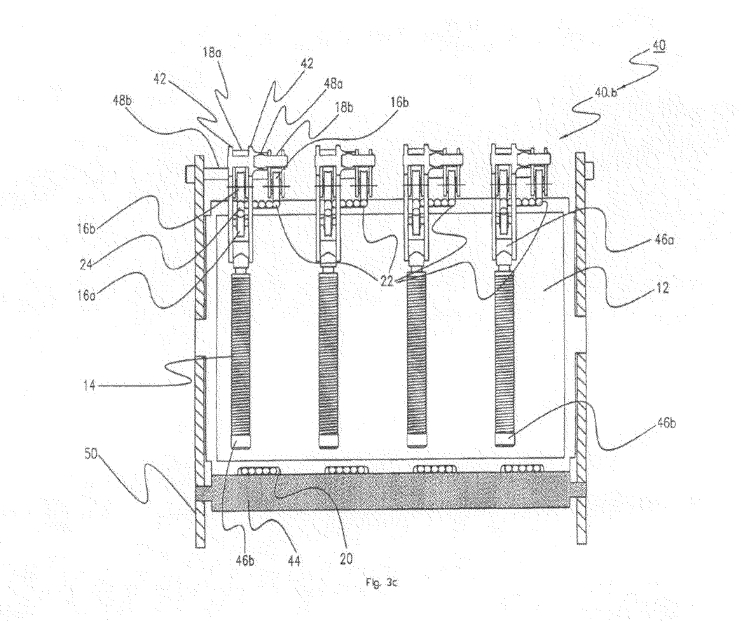

A hoist 40 according to a third embodiment of the invention is shown in FIG. 3a, FIG. 3b and FIG. 3c. The hoist 40 is preferably implemented in a first configuration 40a as shown in FIG. 3a and a second configuration 40b as shown in FIG. 3c.

FIG. 3a provides a side view of the first configuration 40a of the hoist 40 and FIG. 3b provides a cross sectional view of the first configuration 40a of the hoist 40 along line B-B′. FIG. 3c provides a side view of the second configuration 40b of the hoist 40.

Referring to FIG. 3a, the first configuration 40a comprises the drum 12, the plurality of guides 16, a plurality of the guide support 18 and a lever member 42. The plurality of guides 16 preferably comprise a first guide member 16a and second guide members 16b. The plurality of the guide support 18 preferably comprise at least a first guide support member 18a and a second guide support member 18b. The first configuration 40a further comprises the biasing device 14, one or more pressure rollers 44, a first stopper member 46a and a second stopper member 46b. Each of the first and second guide support members 18a/18b inter-couples the second guide members 16b.

The first and second guide support members 18a/18b and the lever member 42 are preferably inter-coupled by a first coupling member 48a. The lever member 42 is preferably further coupled, by a second coupling member 48b, to a common structure 50. The second coupling member 48b is preferably a pivot point about which the lever member 42 pivots. Preferably, the first stopper member 46a is also coupled to the common structure 50.

The pressure rollers 44 are coupled to the drum 12, along its periphery. Each of the pressure rollers 44 is preferably individually coupled to the periphery of the drum 12. Alternatively, each of the pressure rollers 44 is inter-coupled to another to form a pressure roller unit (not shown) prior to being coupled along the periphery of the drum 12. Each of the pressure rollers 42 are inter-coupled to each other by, for example, a chain or roller chain. In one variation, each of the pressure rollers 44 has a substantially smooth surface. In another variation, each of the pressure rollers 44 comprises a plurality of grooves (not shown) such that each of the pressure rollers 44 has a grooved surface.

The second guide members 16b are rotatable and a portion of the cable 22 is clasped between the second guide members 16b and the drum 12. The clasped portion of the cable 22 is substantially adhered to the drum surface 20. In an event where the clasped portion of the cable 22 is not fully adhered to the drum surface 20, the pressure rollers 44 serve to further adhere the clasped portion of the cable 22 to the drum surface 20.

In one example, the first and second guide support members 18a/18b and the lever member 42 form a biasing mechanism. In another example, the biasing device 14, the first and second guide support members 18a/18b, the lever member 42 and the first and second stopper members 46a/46b form a biasing mechanism. The biasing device 14 is, for example, a spring member and tension is provided by the biasing mechanism upon the biasing device 14 being compressed.

In a first exemplary operation where the biasing mechanism comprises the first and second guide support members 18a/18b and the lever member 42, the second guide members 16b are biased toward the drum surface 20 of the drum 12, prior to introduction of the cable 22 to the drum 12 by, for example, gravity. In this instance the biasing mechanism is substantially tensionless.

Upon introduction of the cable 22 to the drum 12 via the first guide member 16a, the lever member 42 pivots about the second coupling member 48b. The cable 22 is preferably introduced via the first guide member 16a such that the cable 22 presses against the first guide member 16a. As the cable 22 presses against the first guide member 16a, the second guide members 16b are further biased toward the drum surface 20 of the drum 12.

The cable 22 can be pressed against the first guide member 16a by, for example, loading and biasing the cable 22 towards the first guide member 16a via a pulley (not shown).

The cable 22 contacts the second guide members 16b so that the second guide members 16b are displaced away from the drum surface 20 of the drum 12. Therefore tension is provided by the biasing mechanism, further adhering the clasped portion of the cable 22 to the drum surface 20.

In a second exemplary operation where the biasing mechanism of the first exemplary operation further comprises the biasing device 14 and the first and second stopper members 46a/46b, the second stopper member 46b is moved towards the first stopper member 46a as the lever member 42 is pivoted such that the second guide members 16b are displaced away from the drum surface 20 of the drum 12. The biasing device 14 is consequently compressed between the first and second stopper members 46a/46b. As the basing device 14 is compressed, tension is provided by the biasing mechanism.

As mentioned earlier, the tension provided serves to further adhere the clasped portion of the cable 22 to the drum surface 20. Apparent from the above, the second guide members 16b can function as a fulcrum for the lever member 42. The amount of tension provided is controllable by adjusting displacement of the fulcrum and the second coupling member 48b.

FIG. 3c provides a side view of the second configuration 40b. As shown, a plurality of cables 22 are wound round the drum surface 20. Tension is applied to each of the plurality of cables 22 as described in the exemplary operations of the first configuration 40a.

Each of the hoist 10 and the hoist 40 is implementable in several ways with three exemplary configurations described hereinafter for hoisting the load (all not shown). In each of the exemplary configurations, the load is a gondola suspendable and positionable along a face of a fixed structure such as a building. The exemplary configurations are described hereinafter with respect to the hoist 10. It can be appreciated that the hoist 40 can also be implemented similarly to the hoist 10.

In a first exemplary configuration for implementing the hoist 10, the anchored end 24 is anchored to the top of a structure, for example a building, with the hoist 10 being mounted to the gondola.

In a second exemplary configuration for implementing the hoist 10, the anchored end 24 is anchored to the gondola with the hoist 10 being mounted to the top of the building.

In a third exemplary configuration for implementing the hoist 10, both the anchored end 24 and the hoist 10 are respectively anchored and mounted to the top of the building. The portion of the cable 22 extending between the anchored end 24 and the drum 12 forms a loop with a pulley being mounted to a portion thereof. The pulley is mounted to the gondola for connecting the gondola with the hoist 10 by means of the cable 22.

In each of the three exemplary configurations, when the hoist 10 is in operation, the gondola is positionable along the face of the building for lifting or lowering objects or individuals contained in the gondola.

In the foregoing manner, a hoist for hoisting a load is described according to embodiments of the invention for addressing at least one of the foregoing problems. Although only a few embodiments of the invention are disclosed, the invention is not to be limited to specific forms or arrangements of parts so described and it will be apparent to one skilled in the art in view of this disclosure that numerous changes and/or modification can be made without departing from the scope and spirit of the invention.

1. A hoist comprising:
a drum having a drum surface for supporting a cable thereon, the cable having an anchored end;
a biasing mechanism; and
at least one guide coupled to the biasing mechanism, the biasing mechanism for biasing the at least one guide towards the drum for clasping at least one portion of the cable between the at least one guide and the drum to substantially adhere the clasped at least one portion of the cable to the drum surface,
wherein when a portion of the cable extending between the anchored end and the drum is in tension, slippage between the drum surface and the clasped at least one portion of the cable is substantially impeded and the drum is rotationally displaceable for displacing the clasped at least one portion of the cable away from the at least one guide.

2. The hoist as in claim 1, further comprising:
an actuator, the drum being coupled to the actuator and the actuator being operable for controlling rotational displacement of the drum.

3. The hoist as in claim 2, the actuator being an electric motor.

4. The hoist as in claim 2, the actuator comprising:
a crank mechanism, the drum being coupled to the crank mechanism, the crank mechanism is operable for rotationally displacing the drum.

5. The hoist as in claim 1, the biasing mechanism comprising:
at least one biasing arm for biasing the at least one guide towards the drum.

6. The hoist as in claim 1, the at least one guide being at least one roller.

7. The hoist as in claim 1, the biasing mechanism comprising:
a biasing device; and
a guide support being elongated and having a first end and a second end, the at least one guide being coupled to the guide support, the guide support being coupled to the biasing device,
wherein the biasing device is for biasing the first end away from the second end of the guide support and for cooperating with the guide support to bias the at least one guide towards the drum.

8. The hoist as in claim 1, further comprising:
a housing for supporting the biasing mechanism, the housing being couplable to the drum.

9. The hoist as in claim 7, the at least one guide being at least one roller rotatably coupled to the guide support.

10. The hoist as in claim 7, the guide support being one of a chain and a roller chain.

11. The hoist as in claim 1, the drum surface being substantially hyperbolical.

12. A hoist comprising:
a drum having a drum surface for supporting a cable thereon, the cable having an anchored end;
a plurality of guides;
a guide support for inter-coupling the plurality of guides; and
a biasing device cooperating with the guide support for biasing the plurality of guides towards the drum for clasping at least one portion of the cable between the plurality of guides and the drum to substantially adhere the clasped at least one portion of the cable to the drum surface,
wherein when a portion of the cable extending between the anchored end and the drum is in tension, slippage between the drum surface and the clasped at least one portion of the cable is substantially impeded and the drum is rotationally displaceable for displacing the clasped at least one portion of the cable away from the plurality of guides.

13. The hoist as in claim 12, further comprising:
an actuator, the drum being coupled to the actuator and the actuator being operable for controlling rotational displacement of the drum.

14. The hoist as in claim 13, the actuator being an electric motor.

15. The hoist as in claim 13, the actuator comprising:
a crank mechanism, the drum being coupled to the crank mechanism, the crank mechanism is operable for rotationally displacing the drum.

16. The hoist as in claim 12, further comprising:
a housing for supporting the biasing device and the guide support, the housing being couplable to the drum.

17. The hoist as in claim 12, the plurality of guides being a plurality of rollers.

18. The hoist as in claim 12, the guide support being elongated and having a first end and a second end, the plurality of guides being coupled to the guide support, wherein the first end is biased away from the second end of the guide support to bias the plurality of guides towards the drum.

19. The hoist as in claim 18, the plurality of guides being a plurality of rollers rotatably coupled to the guide support.

20. The hoist as in claim 18, the guide support being one of a chain and a roller chain.

21. The hoist as in claim 12, the drum surface being substantially hyperbolical.

22. A cable adherence apparatus comprising:
a plurality of guides;
a guide support for inter-coupling the plurality of guides; and
a biasing device, the guide support being coupled to the biasing device, the biasing device being couplable to a drum assembly comprising a drum, the drum having a drum surface for supporting a cable thereon, the cable having an anchored end, the biasing device for cooperating with the guide support for biasing the plurality of guides towards the drum for clasping at least one portion of the cable between the plurality of guides and the drum to substantially adhere the clasped at least one portion of the cable to the drum surface,
wherein when a portion of the cable extending between the anchored end and the drum is in tension, slippage between the drum surface and the clasped at least one portion of the cable is substantially impeded and the drum is rotationally displaceable for displacing the clasped at least one portion of the cable away from the plurality of guides.

23. The apparatus as in claim 22, further comprising:
an actuator, the drum being coupled to the actuator and the actuator being operable for controlling rotational displacement of the drum.

24. The apparatus as in claim 23, the actuator being an electric motor.

25. The apparatus as in claim 23, the actuator comprising:
a crank mechanism, the drum being coupled to the crank mechanism, the crank mechanism is operable for rotationally displacing the drum.

26. The apparatus as in claim 22, further comprising:
a housing for supporting the biasing device and the guide support, the housing being couplable to the drum.

27. The apparatus as in claim 22, the plurality of guides being a plurality of rollers.

28. The apparatus as in claim 22, the guide support being elongated and having a first end and a second end, the plurality of guides being coupled to the guide support, wherein the first end is biased away from the second end of the guide support to bias the plurality of guides towards the drum.

29. The apparatus as in claim 28, the plurality of guides being a plurality of rollers rotatably coupled to the guide support.

30. The apparatus as in claim 28, the guide support being one of a chain and a roller chain.

31. The apparatus as in claim 22, the drum surface being substantially hyperbolical.

32. A hoist comprising:
a drum having a drum surface for supporting a cable thereon, the cable having an anchored end;
a plurality of guide members being one of biasable towards and displaceable away from the drum surface, the plurality of guide members comprising:
a first guide member for guiding the cable to the drum; and
second guide members for clasping at least one portion of the cable between the second guide members and the drum, wherein guidance of the cable via the first guide member biases the second guide members towards the drum surface to substantially adhere the clasped at least one portion of the cable to the drum surface,
wherein when a portion of the cable extending between the anchored end and the drum is in tension, slippage between the drum surface and the clasped at least one portion of the cable is substantially impeded and the drum is rotationally displaceable for displacing the clasped at least one portion of the cable away from the plurality of guide members.

33. The hoist as in claim 32 further comprising a biasing device cooperating with the plurality of guide members, biasing of the second guide members toward the drum surface releasing tension in the biasing device and the displacement of the second guide members away from the drum surface producing tension in the biasing device.

34. The hoist as in claim 33 further comprising a first stopper member and a second stopper member, the biasing device being disposed between the first and second stopper members.

35. The hoist as in claim 34, the biasing device being a spring member compressable between the first and second stopper members for producing tension.

36. The hoist as in claim 35, displacement of the plurality of guide members away from the drum surface causes the biasing device to be compressed between the first and second stopper members for producing tension.

37. The hoist as in claim 34 further comprising a lever member coupling the plurality of the guide members and the biasing device, the lever member for translating displacement of the plurality of guide members away from the drum surface into displacement of the first and second stopper members toward each other, thereby compressing the biasing device for producing tension.

38. The hoist as in claim 32 further comprising at least one pressure roller coupled to the drum to further adhere the clasped portion of the cable to the drum surface.

39. A hoist comprising:
a drum having a drum surface for supporting a cable thereon, the cable having an anchored end;
a plurality of guide members being one of biasable towards and displaceable away from the drum surface, the plurality of guide members comprising:
a first guide member for guiding the cable to the drum; and
second guide members for clasping at least one portion of the cable between the second guide members and the drum, and
a biasing device cooperating with the plurality of guide members, biasing of the second guide members toward the drum surface releasing tension in the biasing device and the displacement of the second guide members away from the drum surface producing tension in the biasing device,
wherein when a portion of the cable extending between the anchored end and the drum is in tension, slippage between the drum surface and the clasped at least one portion of the cable is substantially impeded and the drum is rotationally displaceable for displacing the clasped at least one portion of the cable away from the second guide members.
